(19) United States
(12) Patent Application Publication
(10) Pub. No.: US 2006/0218325 A1
(43) Pub. Date: Sep. 28, 2006

(54) System and method to configure devices for multiple users

(76) Inventor: Carl C. Hansen, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/090,384

(22) Filed: Mar. 25, 2005

(51) Int. Cl. G06F 13/38

(52) U.S. Cl. 710/72

(57) ABSTRACT

A method and system for configuring a device for multiple users. The method includes receiving identification information about a user and then configuring a device based on the received identification information. The device is capable of being used by multiple users, and once configured, is capable of providing the user with access to a block of a resource that is not accessible by any of the other multiple users.

### BACKGROUND

The importance for the consumer electronic device industry to continuously strive to produce devices that are convenient to use cannot be overstated. No doubt this is one of the reasons for making devices that contain more storage capacity and offer more user options. For example, as flash memory becomes less expensive and more efficient, mobile phones, digital camera, digital camcorders, personal digital assistants (PDAs) and so forth are able to store an increasing amount of digital pictures and/or video clips. Configurable user options for such devices may include options such as configurable ring styles to indicate an incoming call or text message, configuable display menus, and so forth.

Convenience of use for a device may decrease if multiple users use the same device. For example, today digital cameras use flash memory that is capable of storing hundreds of pictures. All pictures are stored in the sequence they are taken. Thus, when multiple users take pictures with the same camera it is difficult for any particular user to maintain his or her pictures and to ensure that no other users delete his or her pictures. Also, if one user configures or changes the settings on a device then the next user has to either conform to the previous user's settings or take the time to reconfigure or change the settings on the device before each use.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for configuring a device for multiple users, in which some embodiments of the present invention may operate;

FIG. 2 is a flow diagram of one embodiment of a process for the operation of populating a user profile database and allocating memory;

FIG. 3 is a flow diagram of one embodiment of a process for identifying a user and configuring a device for a specific user; and

FIG. 4 is a flow diagram of one embodiment of a process for configuring a device for the specific user.

### DESCRIPTION OF EMBODIMENTS

A method and system for configuring a device for multiple users are described. Here, at least some of the problems described above may be alievated by configuring a device used by multiple users in such a way that it appears to each indivdual user that the device is only used by him or her. For example, the device may allocate and manage a part or a block of a resource for each user that is not accessible by the other users of the device. Additionally, each time the individual user uses the device the device may be automatically configured with options and/or settings determined by the user. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

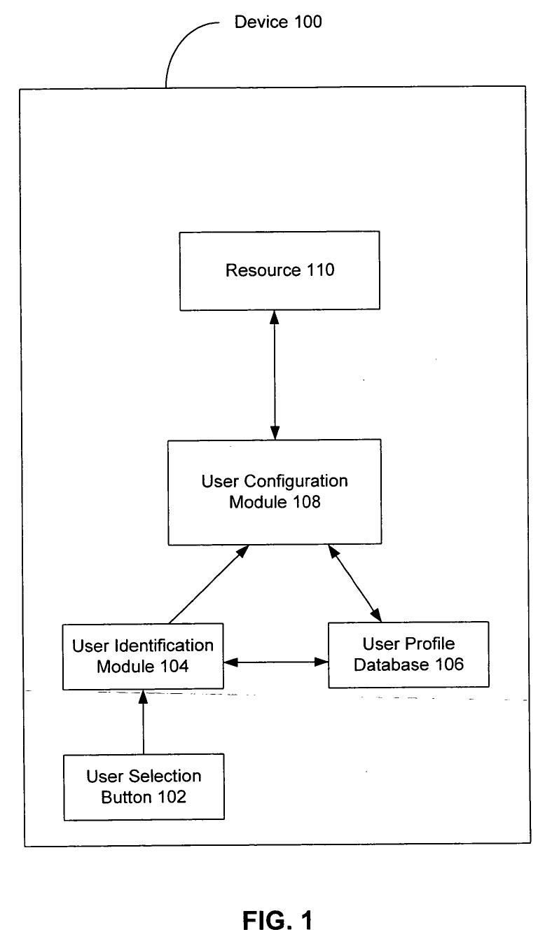

FIG. 1 illustrates one embodiment of an environment for configuring a device for multiple users, in which some embodiments of the present invention may operate. The specific components shown in FIG. 1 represent one example of a configuration that may be suitable for the invention and is not meant to limit the invention.

Referring to FIG. 1, the environment for configuring a device 100 for multiple users may include, but is not necessarily limited to, a user selection button 102, a user identification module 104, a user profile database 106, a user configuration module 108 and a resource 110. Other embodiments of the invention may include more or less components as described in FIG. 1. For example, the functionality of two or more components of FIG. 1 may be combined into one component. Likewise, the functionality of one component of FIG. 1 may be separated and performed by more than one component. Each of the components shown in FIG. 1 is described next in more detail.

In general, device 100 is any device that is capable of storing a large amount of user data via resource 110 and/or is capable of being configured according to one or more users' settings or options. In an embodiment, device 100 may be an application-specific device. For example, device 100 may include, but is not limited to, a digital camera, a digital camcorder, a personal digital assistant (PDA), a mobile phone, a media center, a digital video disk (DVD) player, a set-top box, a personal video recorder (PVR), a MP3 player and so forth. Examples of user data may include, but are not limited to, Joint Photographic Experts Group (JPEG) pictures, Moving Picture Experts Group (MPEG) video clips, text messages, user settings, music and so forth. Examples of user options include, but are not limited to, different ring styles, different menu display options, and so forth. In an embodiment of the invention, resource 110 is any type of electrical or electro-mechanical storage device capable of storing user data. In an embodiment of the invention, resource 110 is a removable flash memory card, although the invention is not limited in this regard.

User selection button 102 may be a hard button or switch or a soft button, for example, implemented via a liquid crystal display (LCD) touch screen on device 100. Button 102 may include functionality to allow a user to enter information to identify him or herself to device 100, although the invention is not limited in this regard. For example, button 102 may have multiple settings for user 1, user 2, etc. Button 102 may also have the capability of allowing a user to enter a user name and password or to accept biometric information from the user for identification. Button 102 may also be implemented as a menu item where the user may scroll through a menu and select him or herself. These example implementations and/or functions of button 102 are provided as illustrations only and are not meant to limit the invention.

User identification module 104 may include functionality to identify the user via the identification information entered via button 102, although the invention is not necessarily limited in this regard. In an embodiment of the invention, identification module 104 compares identification information entered by a user via button 102 with identification information stored in user profile database 106.

In an embodiment of the invention, user profile database 106 may store user identification information, user specific options, the location of user parts or blocks of resource 110 and so forth for each user configured to use device 100. User configuration module 108 may include functionality to configure device 100 for each user and to allocate and ensure that a specific user only has access to his or her block in resource 110, although the present invention is not limited in this regard. User configuration module 108 may be implemented as a hardware element, as a software element executed by a processor, as a silicon chip encoded to perform the functionality of module 108 described herein, or any combination thereof.

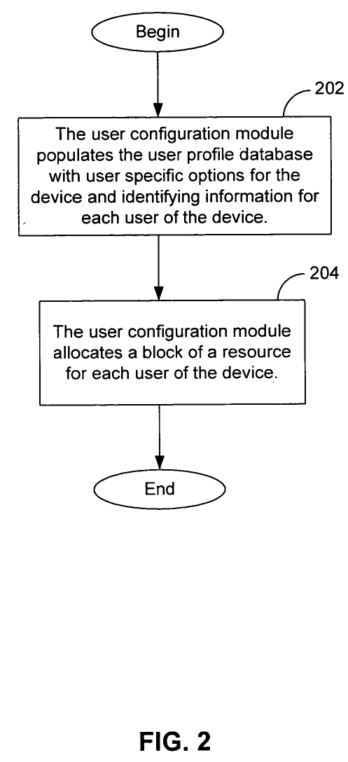

Operations for the above components may be further described with reference to the following FIGS. 2-4 and accompanying examples. In addition, the given operation may be implemented by a hardware element, a software element executed by a processor, as a silicon chip encoded to perform the functionality of module 108 described herein, or any combination thereof. The embodiments of the invention are not limited in this context.

FIG. 2 is a flow diagram of one embodiment of a process for the operation of populating user profile database 106 and allocating blocks from resource 110. Referring to FIG. 2, the process begins at processing block 202 where user configuration module 108 populates user profile database 106. As described above, database 106 may store user identification information, user specific options, the location of user blocks in resource 110 and so forth for each user configured to use device 100. By storing this type of information, device 100 may be reconfigured according to each user's options or settings. This feature of an embodiment of the invention may help to alleviate the problem of one user configuring the settings on a device that the next user has to either conform to or take the time to change before each use.

The data stored in database 106 may be entered directly by a user via an input device (not shown in FIG. 1) into database 106. User data may also be transmitted via a network from another storage device via a near-field communication. The near-field communication may be implemented via infrared technology, Bluetooth technology, radio frequency technology, or a similar near-field communication technology. These examples are not meant to limit the invention.

At processing block 204, user configuration module 108 allocates a block of resource 110 for each user of device 100. The process in FIG. 2 ends at this point.

Typically, when a block of resource 110 is allocated to a particular user, only that user may access the block of resource 110. For example in the case where device 100 is a digital camera and resource 110 is flash memory, the allocation of individual blocks of flash memory for each user keeps the users' digital pictures and/or video clips separate from each other's. Thus, users of device 100 are ensured that no other user will delete his or her pictures and/or video clips. This example implementation of device 100 and resource 110 is provided for illustration purposes only and is not meant to limit the device. In a further embodiment of the invention, resource 110 is an array of memory cells. User configuration module 108 may access and/or maintain a linked list where each entry in the linked list indicates where a specific user's memory block starts and ends in resource 110. This example is provided for illustration purposes only and is not meant to limit the invention.

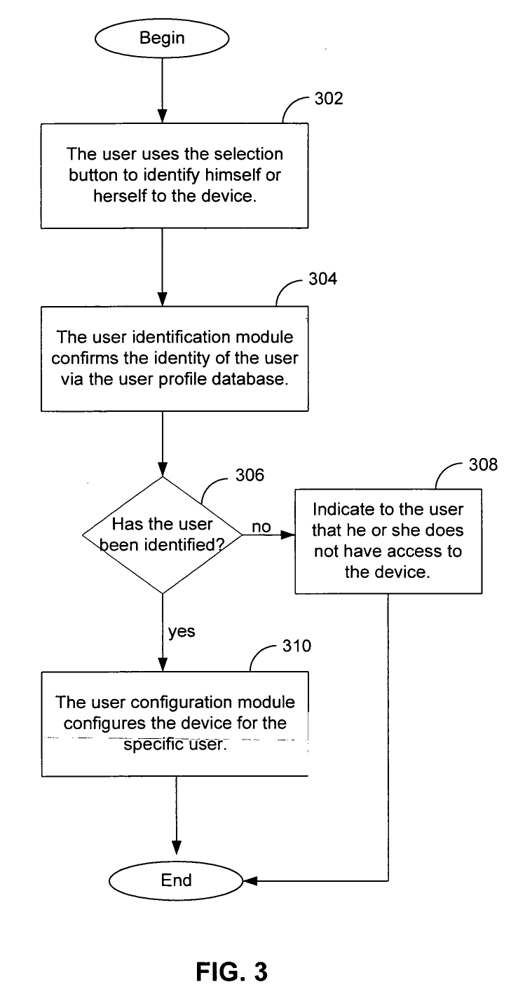

FIG. 3 is a flow diagram of one embodiment of a process for identifying a user and configuring device 100 for that specific user. Referring to FIG. 3, the process begins at processing block 302 where the user uses selection button 102 to identify him or herself to device 100. As described above, button 102 may be a hard button or switch, a soft button or a menu item and allows the user to enter information to identify the user to device 100.

User identification module 104, at processing block 304, utilizes the information entered via user selection button 102 to identify the user. In an embodiment of the invention, module 104 compares information entered via button 102 with information stored in user profile database 106.

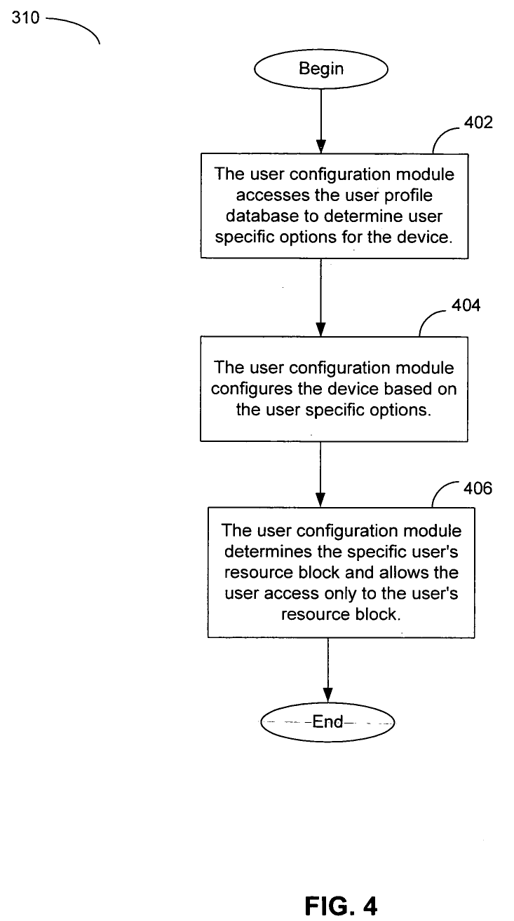

If it is determined in decision block 306 that the user cannot be identified by user identification module 104, then the user is denied access to device 100 in processing block 308. Alternatively, if the user is identified by module 104, then user configuration module 108 configures device 100 for the specific user in processing block 310. The process in FIG. 3 ends at this point. Processing block 310 is described next in more detail with reference to FIG. 4.

FIG. 4 is a flow diagram of one embodiment of a process for configuring device 100 for the specific user (step 310 of FIG. 3). Referring to FIG. 4, the process begins at processing block 402 where user configuration module 108 accesses user profile database 106 to determine user specific options for device 100. Module 108 uses the options to configure device 100. Here, device 100 is configured for the specific user in processing block 404 and may include such things as user specific ring styles, menu display options, and so forth.

At processing block 406, user configuration module 108 determines the specific user's block in resource 110 and allows the user access only to that resource block. The process in FIG. 4 ends at this point.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
receiving identification information about a user; and configuring an application-specific device based on the received identification information, wherein the device is capable of being used by multiple users, wherein the user is one of the multiple users and wherein the device, once configured, is capable of providing the user with access to a block of a resource that is not accessible by any of the other multiple users.

2. The method of claim 1, wherein the device is further capable of providing one or more user options to the user.

3. The method of claim 1, wherein the block of the resource is capable of storing user data.

4. The method of claim 3, wherein the user data may include one or more of digital pictures, digital video clips, text messages, music and user settings.

5. The method of claim 1, wherein the device is one of a digital camera, a digital camcorder, a personal digital assistant (PDA), a mobile phone, a media center, a digital video disk (DVD) player, a set-top box, a personal video recorder (PVR) and a MP3 player.

6. The method of claim 1, wherein configuring the device comprises:
determining one or more user options;
configuring the device by the configuration module based on the one or more user options; and
determining the block of the resource to be accessible only by the user.

7. The method of claim 6, wherein the steps of determining the one or more user options, configuring the device and determining the block of the resource are performed by a user configuration module.

8. The method of claim 7, wherein the user configuration module is implemented as a silicon chip.

9. The method of claim 1, wherein the resource is an electrical storage device.

10. The method of claim 1, wherein the resource is an electro-mechanical storage device.

11. A device comprising:
a user identification module capable of receiving identification information about a user, wherein the user identification module is further capable of utilizing the received identification information to identify the user; and
a user configuration module capable of configuring an application-specific device based on one or more user options associated with the identified user, wherein the user configuration module is further capable of providing the identified user with access to a block of a resource that is not accessible by any other user of the device.

12. The device of claim 11, wherein the block of a resource is capable of storing user data.

13. The device of claim 12, wherein the user data may include one or more of digital pictures, digital video clips, text messages, music and user settings.

14. The device of claim 11, wherein the device is one of a digital camera, a digital camcorder, a personal digital assistant (PDA), a mobile phone, a media center, a digital video disk (DVD) player, a set-top box, a personal video recorder (PVR) and a MP3 player.

15. The device of claim 11, wherein the user configuration module is implemented as a silicon chip.

16. The device of claim 11, further comprising a user selection button, wherein the user selection button is utilized by the user to enter the identification information.

17. The device of claim 16, wherein the user selection button is implemented as either a hard button, a soft button or a menu item.

18. The device of claim 11, wherein the resource is an electrical storage device.

19. The device of claim 11, wherein the resource is an electro-mechanical storage device.

20. A machine-readable medium containing instructions which, when executed by a processing system, cause the processing system to perform a method, the method comprising:
receiving identification information about a user; and
configuring an application-specific device based on the received identification information, wherein the device is capable of being used by multiple users, wherein the user is one of the multiple users and wherein the device, once configured, is capable of providing the user with access to a block of a resource that is not accessible by any of the other multiple users.

21. The machine-readable medium of claim 20, wherein the device is further capable of providing one or more user options to the user.

22. The machine-readable medium of claim 20, wherein the block of the resource is capable of storing user data.

23. The machine-readable medium of claim 22, wherein the user data may include one or more of digital pictures, digital video clips, text messages, music and user settings.

24. The machine-readable medium of claim 20, wherein the device is one of a digital camera, a digital camcorder, a personal digital assistant (PDA), a mobile phone, a media center, a digital video disk (DVD) player, a set-top box, a personal video recorder (PVR) and a MP3 player.

25. The machine-readable medium of claim 20, wherein the resource is an electrical storage device.

26. The machine-readable medium of claim 20, wherein the resource is an electro-mechanical storage device.
